(19) United States
(12) Patent Application Publication
(10) Pub. No.: US 2009/0227445 A1
(43) Pub. Date: Sep. 10, 2009

(54) METHOD OF PREPARING PLATINUM ALLOY CATALYST FOR FUEL CELL ELECTRODE

(75) Inventors: Jae Seung Lee, Seoul (KR); Yung-Eun Sung, Gyeonggi-do (KR); Yong-Hun Cho, Gyeonggi-do (KR); Tae Yeol Jeon, Seoul (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); SEOUL NATIONAL UNIVERSITY INDUSTRY FOUNDATION, Seoul (KR)

(21) Appl. No.: 12/276,782

(22) Filed: Nov. 24, 2008

(30) Foreign Application Priority Data
Mar. 7, 2008 (KR) 10-2008-0021708

(51) Int. Cl. H01M 4/92

(52) U.S. Cl. 502/101

(57) ABSTRACT

A method of preparing a platinum alloy catalyst for a fuel cell electrode includes: (a) adding a carbon material, a platinum precursor, and a transition metal precursor to ethanol and dispersing the mixture; (b) adding sodium acetate powder or an ammonia solution containing ethanol as a solvent to the solution obtained in step (a) and stirring the resulting solution; (c) adding sodium borohydride to the solution obtained in step (b) and reducing the metal ions of the platinum precursor and the transition metal precursor; and (d) obtaining a platinum alloy catalyst in the form of powder through washing and drying processes. This method can reduce the amount of platinum to be used for manufacturing a fuel cell electrode and thereby reduce the manufacturing cost.

### CROSS-REFERENCE TO RELATED APPLICATION

This application claims under 35 U.S.C. §119(a) the benefit of Korean Patent Application No. 10-2008-0021708 filed Mar. 7, 2008, the entire contents of which are incorporated herein by reference.

### BACKGROUND

(a) Technical Field

The present invention relates to a method of preparing a platinum alloy catalyst for a fuel cell electrode. More particularly, the present invention relates to a method of preparing a highly active platinum alloy nanocatalyst which can be used as an electrode material for a polymer electrolyte membrane fuel cell (PEMFC).

(b) Background Art

In general, a fuel cell is an electricity generation device that does not converts chemical energy of fuel into heat by combustion, but electrochemically converts the chemical energy directly into electrical energy in a fuel cell stack. Such a fuel cell can be applied to the supply of electric power for small-sized electrical/electronic devices, especially, portable devices, as well as to the supply of electric power for industry, home, and vehicle.

At present, the most attractive fuel cell for a vehicle is a PEMFC, also called a proton exchange membrane fuel cell. The PEMFC has the highest power density among the fuel cells. It also has a fast start-up time and a fast reaction time for power conversion due to its low operation temperature.

The PEMFC comprises: a membrane electrode assembly (MEA) including a polymer electrolyte membrane for transporting hydrogen ions and an electrode/catalyst layer, in which an electrochemical reaction takes place, disposed on both sides of the polymer electrolyte membrane; a gas diffusion layer (GDL) for uniformly diffusing reactant gases and transmitting generated electricity; a gasket and a sealing member for maintaining airtightness of the reactant gases and coolant and providing an appropriate bonding pressure; and a bipolar plate for transferring the reactant gases and coolant.

In the fuel cell having the above-described configuration, hydrogen as a fuel is supplied to an anode (also referred to as a fuel electrode or oxidation electrode), and oxygen (air) as an oxidizing agent is supplied to a cathode (also referred to as an air electrode, oxygen electrode, or reduction electrode).

The hydrogen supplied to the anode is dissociated into hydrogen ions (protons, H⁺) and electrons (e⁻) by a catalyst of the electrode/catalyst layer provided on both sides of the electrolyte membrane. At this time, only the hydrogen ions are transmitted to the cathode through the electrolyte membrane, which is a cation exchange membrane, and at the same time the electrons are transmitted to the anode through the GDL and the bipolar plate, which are conductors.

At the anode, the hydrogen ions supplied through the electrolyte membrane and the electrons transmitted through the bipolar plate meet the oxygen in the air supplied to the anode by an air supplier and cause a reaction that produces water.

Due to the movement of hydrogen ions caused at this time, the flow of electrons through an external conducting wire occurs, and thus a current is generated.

The electrode reactions in the polymer electrolyte membrane fuel cell can be represented by the following formulas:

Reaction at the anode: 2H₂→4H⁺+4e⁻

Reaction at the cathode: O₂+4H⁺+4e⁻→2H₂O

Overall reaction: 2H₂+O₂→2H₂O+electrical energy+heat energy

As shown in the above reaction formulas, the hydrogen molecule is dissociated into four hydrogen ions and four electrons at the anode. The generated electrons move through an external circuit to generate a current, and the generated hydrogen ions move to the cathode through an electrolyte to perform reduction electrode reaction.

Accordingly, the efficiency of the fuel cell depends on the rate of the electrode reactions, and thus a nano-sized catalyst is used as an electrode material.

The membrane electrode assembly of the fuel cell stack has a structure in which the anode and cathode are attached to the polymer electrolyte membrane interposed therebetween, and the anode and cathode are formed in such a manner that a catalyst layer including platinum catalyst particles of nano-size is coated on an electrode backing layer such as carbon paper or carbon cloth.

In general, a gas diffusion layer having fine pores and formed by coating carbon black particles on an electrode backing layer such as carbon paper or carbon cloth to uniformly supply reactants to the membrane electrode assembly is called a gas diffusion electrode. The gas diffusion electrode may be subjected to a hydrophobic process with fluorine resin so as to discharge reaction by-products electrochemically generated on the catalyst layer of the cathode.

The membrane electrode assembly may be formed in such a manner that a catalyst layer is coated on the gas diffusion layer by an appropriate method and then the gas diffusion layer including the catalyst layer is thermally compressed to an electrolyte membrane. Otherwise, the membrane electrode assembly may be formed in such a manner that a catalyst layer is coated on an electrolyte membrane and then a gas diffusion layer is bonded thereto. The gas diffusion layers in the above structures serve as a current collector at the same time.

However, most of the electrode catalysts used in the fuel cells are precious metals such as platinum, and thus the manufacturing cost is high. The overvoltage of the oxygen reduction reaction at the cathode in the polymer electrolyte membrane fuel cell is more than 10 times greater than that of the hydrogen oxidation reaction at the anode. Moreover, with the use of platinum that is very expensive and has limited deposits, its commercialization has been delayed.

It is reported that the amount of platinum used per kW should be reduced to less than 0.2 g in order to commercialize fuel cell vehicles. For this purpose, numerous technical problems are encountered, and thus extensive research aimed at developing a non-platinum catalyst to solve the economic problem has continued to progress.

However, in terms of the activation of non-platinum catalysts developed so far, there is a difficulty in applying the non-platinum catalysts to the fuel cell electrodes. Accordingly, extensive research and development on alloy catalyst materials in which the amount of platinum used is reduced have continued to progress, separately from the development of non-platinum catalysts.

With the use of alloy catalyst materials, it is possible to reduce the amount of platinum used, compared with the pure platinum catalysts, and it is further possible to manufacture a high-performance catalyst electrode with improved catalyst activation, thus accelerating the commercialization of fuel cell vehicles.

The alloy catalyst has a structure in which more than two metals are alloyed and is thus distinguished from a mixed catalyst in which two elements are mixed.

The alloy catalyst may be exemplified by a crystallized Pt-M alloy, highly dispersed on carbon powder, and the alloy with platinum and 3-d band transition metals is traditionally formed by a polyol process. However, it is known that this process is not suitable for mass production due to the complexity of manufacturing process, heat treatment and various drawbacks encountered during a washing process.

In addition to the polyol process, the synthesis of Pt-M/C catalyst has been performed by a carbonyl complex route, in which a cluster is formed in a synthesis solution using CO gas, dried, and reduced by heat treatment under hydrogen atmosphere at a furnace. However, this method has drawbacks in that the toxic CO gas is used, the synthesis time is increased, and it is difficult to ensure a uniform particle distribution.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides a method of preparing a platinum alloy catalyst for a fuel cell electrode, the method comprising: (a) adding a carbon material, a platinum precursor, and a transition metal precursor to ethanol and dispersing the mixture; (b) adding sodium acetate powder, an ammonia solution containing ethanol as a solvent, or both to the solution obtained in step (a) and stirring the resulting solution; (c) adding sodium borohydride to the solution obtained in step (b) and reducing the metal ions of the platinum precursor and the transition metal precursor; and (d) obtaining a platinum alloy catalyst in the form of powder through washing and drying processes.

In a preferred embodiment, in steps (a) and (b), the ethanol is anhydrous ethanol with a water content of 1% or less.

In another preferred embodiment, in step (a), the ethanol in an amount of 800 to 6400 times the total weight of the metal ions is used, and in step (b), the sodium acetate powder in an amount of 5 to 40 times the total weight of the metal ions is added, or the ammonia solution containing ammonia in an amount of 0.3 to 4 times the total weight of the metal ions is added.

In still another preferred embodiment, the platinum precursor comprises at least one selected from the group consisting of PtCl₄, K₂PtCl₄, H₂PtCl₆.xH₂O, PtCl₂, PtBr₂, and PtO₂.

In yet another preferred embodiment, the platinum precursor comprises platinum in an amount of 5 to 90 wt % based on the total weight of the carbon material.

In still yet another preferred embodiment, the transition metal precursor is a compound comprising at least one selected from the group consisting of Ni, Co, Fe, Cr, Cu, Ru, Pd, Sn, V, Mo, W, and Ir.

In a further preferred embodiment, the transition metal precursor comprises at least one selected from the group consisting of NiCl₂.6H₂O, CoCl₂.6H₂O, NiBr₂, NiCl₂, RuCl₃, CoCl₂, FeCl₂, FeCl₃, FeCl₂.4H₂O, FeCl₃.6H₂O, CrCl₃, CrCl₂, CrCl₃.6H₂O, CuBr₂, CuCl₂, CuCl₂.2H₂O, PdCl₂, PdCl₃, SnCl₂, SnBr₂, SnCl₄, SnCl₂.2H₂O, MoCl₂, MoCl₃, WCl₄, WCl₆, IrCl₃, and IrCl₃.xH₂O.

In another further preferred embodiment, the transition metal precursor comprises a transition metal in an amount of 5 to 60 wt % based on the total weight of the platinum.

In still another further preferred embodiment, the carbon material is one selected from the group consisting of carbon powder, carbon black, acetylene black, ketjen black, active carbon, carbon nanotubes, carbon nanofibers, carbon nanowires, carbon nanohorns, carbon aerogel, carbon xerogel, and carbon nanorings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a process diagram showing a method of preparing a platinum alloy catalyst (Pt-M/C) in accordance with the present invention;

FIG. 2 is a transmission electron microscopy (TEM) image of a platinum-nickel alloy catalyst (PtNi/C) having an atomic ratio of metals of 1:1 and a metal content of 40 wt % prepared in Example 1;

FIG. 3 is a graph showing X-ray diffraction (XRD) patterns of PtNi/C alloy catalysts prepared in Example 1 and Comparative Examples 1 to 3;

FIG. 4 is a graph showing X-ray diffraction (XRD) patterns of a platinum-cobalt alloy catalyst having an atomic ratio of metals of 1:1 and a metal content of 40 wt % prepared in Example 2;

FIG. 5 is a cyclic voltammogram showing the results of cyclic voltammetry measurement of the PtNi/C alloy catalyst prepared in Example 1;

FIG. 6 is a graph showing the results of a rotating disk electrode experiment to measure the activation for oxygen reduction reaction of the PtNi/C alloy catalyst prepared in Example 1;

FIG. 7 is a graph showing the results of a unit cell evaluation of the PtNi/C alloy catalyst prepared in Example 1; and

FIG. 8 is a table showing the results of atomic ratios of platinum and nickel in the alloy catalysts prepared in Example 1 and Comparative Examples 1 to 3, measured using an inductively coupled plasma atomic emission spectrometer.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

As discussed above, the present invention provides a method of preparing a platinum alloy catalyst for a fuel cell electrode, and more particularly, the present invention provides a high active platinum alloy nanocatalyst which can be used as an electrode material for a polymer electrolyte membrane fuel cell. The alloy nanocatalyst prepared by the present invention can be usefully applied to a cathode electrode for oxygen reduction reaction. The alloy nanocatalyst prepared by the present invention comprises a highly dispersed platinum and a transition metal (nickel, cobalt, iron, chromium, ruthenium, copper, etc.), and can be used as a material for both an oxygen reduction electrode (cathode) and a hydrogen oxidation electrode (anode). With the use of the alloy nanocatalyst of the present invention, it is possible to reduce the amount of platinum to be used, thus reducing manufacturing cost.

The preparation method of the present invention will be described in more detail.

As discussed above, the method comprises: (a) adding a carbon material, a platinum precursor, and a transition metal precursor to ethanol and dispersing the resulting mixture; (b) adding sodium acetate powder, an ammonia solution containing ethanol as a solvent, or both to the solution obtained in step (a); (c) adding sodium borohydride to the solution obtained in step (b) and reducing the metal ions of the platinum precursor and the transition metal precursor); and obtaining a platinum alloy catalyst in the form of powder through washing and drying processes.

In more detail, a carbon material, a platinum precursor, and a transition metal precursor are dispersed in ethanol to prepare a mixture. To this mixture, sodium acetate powder, an ammonia solution containing ethanol as a solvent, or both is added. The sodium acetate powder and ammonia solution help the formation of alloy nanoparticles.

Preferably, as the ethanol used as a solvent, anhydrous ethanol containing no or less amount of water is used, which helps to obtain a catalyst with a higher alloy content. Preferably, anhydrous ethanol having a water content of 1% or less is used.

For example, an appropriate amount of the carbon material is added to anhydrous ethanol having a water content of 1% or less and dispersed through stirring, sonication, and stirring for an appropriate period of time, respectively. Preferably, the carbon material is added to ethanol and dispersed by performing stirring for about 30 minutes, sonication for about 20 minutes, and stirring for about 30 minutes.

In this case, the carbon material may be one or more selected from the group consisting of carbon powder, carbon black, acetylene black, ketjen black, active carbon, carbon nanotubes, carbon nanofibers, carbon nanowires, carbon nanohorns, carbon aerogel, carbon xerogel, and carbon nanorings.

Subsequently, a metal precursor solution is prepared by dissolving a platinum precursor and a transition metal precursor (e.g., a nickel precursor) in ethanol (e.g., anhydrous ethanol having a water content of 1% or less). The metal precursor solution is then added to the ethanol solution containing the carbon material dispersed therein.

The amount of platinum precursor used is adjusted so that the amount of pure platinum is 5 to 90 wt % based on the total weight of the carbon material. Moreover, the amount of transition metal precursor used is adjusted so that the amount of pure transition metal is 5 to 60 wt % based on the total weight of the carbon material.

The platinum precursor may comprise at least one selected from the group consisting of PtCl₄, K₂PtCl₄, PtCl₂, PtBr₂, and PtO₂ having no water molecules, and H₂PtCl₆.xH₂O containing water molecules.

The transition metal precursor may be a compound comprising at least one selected from the group consisting of Ni, Co, Fe, Cr, Cu, Ru, Pd, Sn, V, Mo, W, and Ir. For example, the transition metal precursor may comprise at least one compound containing water molecules selected from the group consisting of NiCl₂.6H₂O, CoCl₂.6H₂O, FeCl₂.4H₂O, FeCl₃.6H₂O, CrCl₃.6H₂O, CuCl₂.2H₂O, SnCl₂.2H₂O, IrCl₃.xH₂O including Ni, Co, Fe, Cr, Cu, Sn, and Ir, or may comprise at least one compound containing no water molecules selected from the group consisting of NiBr₂, NiCl₂, RuCl₃, CoCl₂, FeCl₂, FeCl₃, CrCl₃, CrCl₂, CuBr₂, CuCl₂, PdCl₂, PdCl₃, SnCl₂, SnBr₂, SnCl₄, MoCl₂, MoCl₃, WCl₄, WCl₆ and IrCl₃ including Ni, Co, Cu, Fe, Ru, Cr, Pd, Sn, Mo, W, and Ir.

It is preferable to use 100 to 800 mL of ethanol with respect to 0.1 g of the total metal ions (i.e., 800 to 6400 times the total weight of the metal ions; ethanol density of 0.8 g/mL). If ethanol is used in an amount less than 800 times the total weight of the metal ions (here, 100 mL), cohesion between alloy nanoparticles may occur during metal reduction, and thus the dispersion of alloy nanoparticles may be deteriorated. To the contrary, if it is used in an amount more than 6400 times the total weight of the metal ions (here, 800 mL), the transition metal may not be reduced.

Next, as a continuous process, an appropriate amount of sodium acetate powder, ammonia solution, or a mixture thereof is added. Preferably, the addition amount may be about 10 times the molar ratio of platinum. It is apparent that an appropriate amount of sodium acetate and ammonia should be used in accordance with a change in the amount of solvent (ethanol), or a change in the amount of metals.

Preferably, sodium acetate is added in an amount of 5 to 40 times the total weight of the metal ions. If sodium acetate is used in an amount less than 5 times the total weight of the metal ions, the function of forming aggregates between the platinum precursor compound and the transition metal precursor compound is weakened before reduction, the function as a stabilizer is reduced due to a low concentration after reduction, and thus it is difficult to obtain a uniform nanoparticle size distribution. On the other hand, if sodium acetate is used in an amount exceeding 40 times the total weight of the metal ions, individual interactions between the platinum precursor compound and the transition metal precursor compound are strongly performed due to the increased concentration of the sodium acetate, and thus individual platinum and individual transition metal nanoparticles are generated after reduction.

Since the alloy on an atomic level shows a high activity in the fuel cell, there exists an optimum concentration range of sodium acetate in the present invention. For example, when ethanol is used in an amount of 3200 times the total weight of the metal ions, the sodium acetate may be used 10 to 25 times the total weight of the metal ions.

When the ammonia solution is added instead of sodium acetate, it is preferable to adjust the amount of ammonia solution to be 0.3 to 4 times the total weight of the metal ions. Here, the ammonia solution may be a 2 mol/L ammonia ethanol solution in which ammonia is dissolved in ethanol (e.g., anhydrous ethanol having a water content of less than 1%). If ammonia is used in an amount less than 0.3 times the total weight of the metal ions, a complete interaction with the total metal precursor compound is impossible due to the low concentration. Accordingly, the transition metal may not be reduced as much as the added amount but lost. By contrast, if ammonia is used in an amount exceeding 4 times the total weight of the metal ions, the bonding force with the platinum precursor compound is increased and thus a small amount of platinum may not be reduced.

Since the alloy on an atomic level shows a high activity in the fuel cell, there exists an optimum concentration range of ammonia in the present invention. For example, if ethanol is used in an amount of 3200 times the total weight of the metal ions, the ammonia may be used in the range of 0.5 to 2.2 times the total weight of the metal ions.

In case where a mixture of sodium acetate and ammonia is added, ammonia of 0.5 to 2.2 times the total weight of the metal ions and sodium acetate of 10 to 25 times the total weight of the metal ions can be used.

Subsequently, the resulting mixture is stirred for 4 to 12 hours and, particularly, for at least 4 hours so that the metal precursor can be completely mixed with sodium acetate or ammonia.

Next, sodium borohydride powder as a reducing agent is dissolved in an appropriate amount of ethanol and then added. For example, sodium borohydride is dissolved in ethanol of about ⅙ volume of the total volume of the solution. At this time, it is preferable that the amount of sodium borohydride be 2 to 5 equivalents with respect to platinum having a valence of +4 in consideration of oxidation state of the total metals. Here, “1 equivalent” means 1 mole of sodium borohydride capable of reducing 1 mole of platinum having a valence of +4. During the addition of the reducing agent, the stirring rate of the solution is increased to the maximum so that the added sodium hydride may be reduced by reacting with the metal precursor as soon as possible.

Suitably, nitrogen or argon is continuously injected before the mixed solution of the platinum precursor and the transition metal precursor is added and until the metal reduction by the reducing agent is complete, thus preventing the generation of metallic oxide.

Thereafter, the resulting mixture is washed. In the washing process, preferably, deionized (DI) water is used. After the washing process, it is dried in the temperature range of 30 to 100° C., thus preparing an alloy catalyst in the form of powder. At this time, if the temperature is less than 30° C., it takes a long time to form the dried powder or may produce an incompletely dried powder. On the other hand, if the temperature exceeds 100° C., the catalyst may be oxidized.

Hereinafter, the present invention will be described with reference to the following examples; however, the present invention is not limited to the examples.

### Examples and Comparative Examples

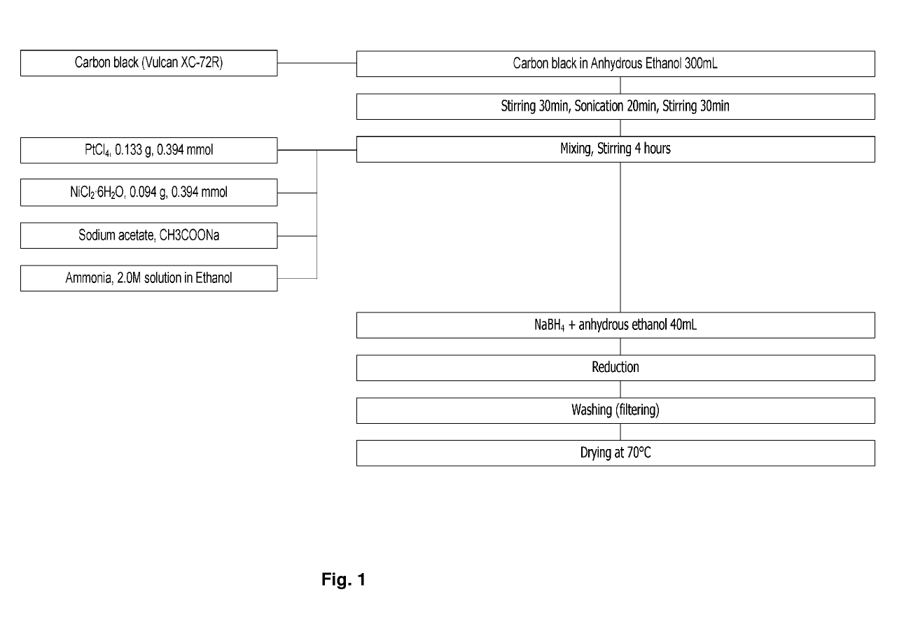

In Example 1, a PtNi/C alloy electrode material having a metal content of 40 wt % was prepared in accordance with the preparation method of the present invention. The preparation process will be described in detail with reference to FIG. 1 below.

First, 0.15 g of carbon carrier (Cabot, Vulcan XC-72R) was added to 300 mL of anhydrous ethanol having a water content of 1% or less and stirred for about 30 minutes, sonicated for about 20 minutes, and stirred for about 30 minutes.

Then, 0.1328 g of platinum precursor (PtCl₄) and 0.0937 g of nickel precursor (NiCl₂.6H₂O) were placed in a 20 mL vial, respectively, 20 mL of anhydrous ethanol was added thereto to dissolve the precursors, and the resulting solutions were added to the solution containing carbon carrier dispersed therein.

Subsequently, 1.455 g of sodium acetate powder was added to the solution and stirred for at least 4 hours, thereby dissolving sodium acetate in ethanol and bonding with the metal precursors.

Next, 0.112 g of sodium borohydride (NaBH₄) was placed in a 20 mL vial, and 20 mL of anhydrous ethanol was added and subjected to external vibration for about 1 minute to dissolve the sodium borohydride. The thus-prepared solution containing 20 mL of ethanol solution was added to the solution containing metal precursors dissolved therein and vigorously stirred for about 30 minutes, and maintained for at least one and half hour at a reduced stirring rate. Before adding the solution containing 20 mL. of ethanol solution to the solution containing metal precursors, the solution containing metal precursors was stirred for about 1 minute and sonicated for about 15 seconds, and the stirring rate is increased to the maximum. It has been reported that all metal precursor compounds can be reduced for at least about 2 hours under metal reduction conditions in which water is not present.

Thereafter, the alloy nanoparticle catalyst carried on carbon can be obtained after a washing process using Di-water and a drying process at 70° C.

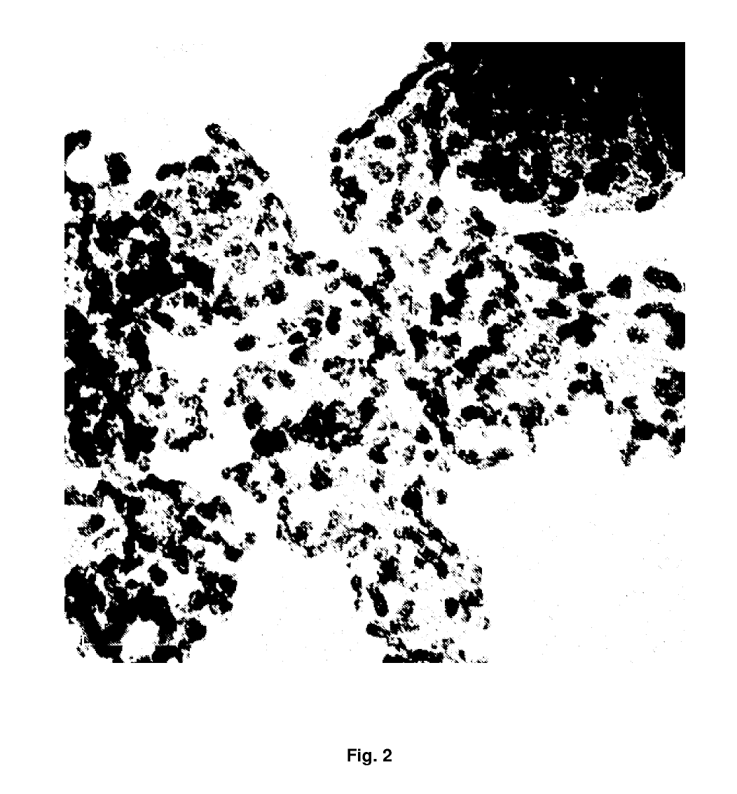

FIG. 2 is a transmission electron microscopy (TEM) image of the platinum-nickel alloy catalyst (PtNi/C) having an atomic ratio of metals of 1:1 and a metal content of 40 wt % prepared in Example 1. It can be seen from the figure that PtNi alloy nanoparticles having a diameter of about 3 to 5 mm are formed. Moreover, it can be seen that the PtNi alloy nanoparticles are very densely dispersed since the total weight of the metals occupies 40 wt % based on the total weight of the catalyst. A considerable amount of particles are adhered to each other. The reason for this is considered that the molar ratio of the total metals is increased since nickel having a weight of about ⅓ or less of that of platinum is present at about 50 atomic percent. As a result, a large number of particles are formed such that the area required for carrying the metals is insufficient.

Example 2 is the same as Example 1 except that an alloy catalyst was prepared using Co as the transition metal instead of Ni.

Comparative Example 1 is the same as Example 1 except that the sodium acetate as the stabilizer was not added.

Comparative Example 2 is the same as Example 1 except that ammonium was used as the stabilizer instead of sodium acetate.

Comparative Example 3 is the same as Example 1 except that the sodium acetate and ammonium were used together.

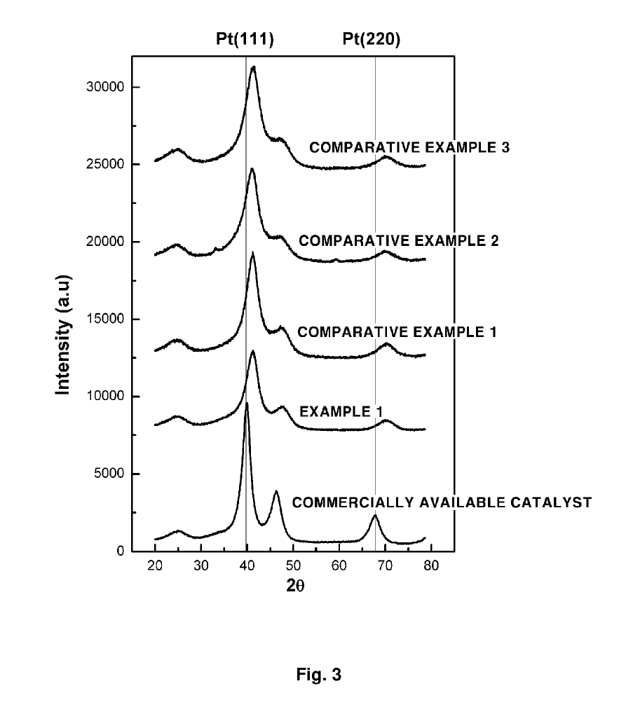

FIG. 3 is a graph showing X-ray diffraction (XRD) patterns of PtNi/C alloy catalysts prepared in Example 1 and Comparative Examples 1 to 3.

In Example 1, only sodium acetate was used as an additive. The commercially available catalyst (40 wt %, Pt/C provided by Johnson & Matthey) shown at the bottom was measured under the same measurement conditions for purposes of comparison. It can be seen that the most significant difference is that peaks of Pt (111) and Pt (220) were shifted to high 2θ values. The reason for this is that the atomic size of Ni is about 11% smaller than that of Pt. Accordingly, since the lattice constant is reduced due to the small-sized Ni when a substitutional solid solution is formed, the peaks are shifted to higher 2θ values by the XRD measurement results. The higher the change in the 2θ value, the higher the alloy content. Since the electrode material prepared in accordance with Example 1 shows a very high peak shift compared with the commercially available catalyst (40 wt %, Pt/C provided by Johnson & Matthey) for comparison, the alloy content of the electrode material prepared in accordance with Example 1 is very high.

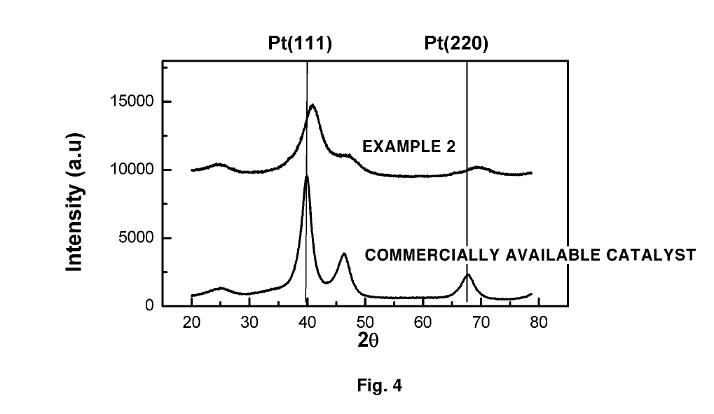

FIG. 4 is a graph showing X-ray diffraction (XRD) patterns of the platinum-cobalt alloy catalyst having an atomic ratio of metals of 1:1 and a metal content of 40 wt % prepared in Example 2. The commercially available catalyst (40 wt %, Pt/C provided by Johnson & Matthey) shown at the bottom was measured under the same measurement conditions for purposes of comparison. As described above with reference to FIG. 3, the most significant difference is that peaks of Pt (111) and Pt (220) were shifted to high 20 values, and the reason for this is the same as above.

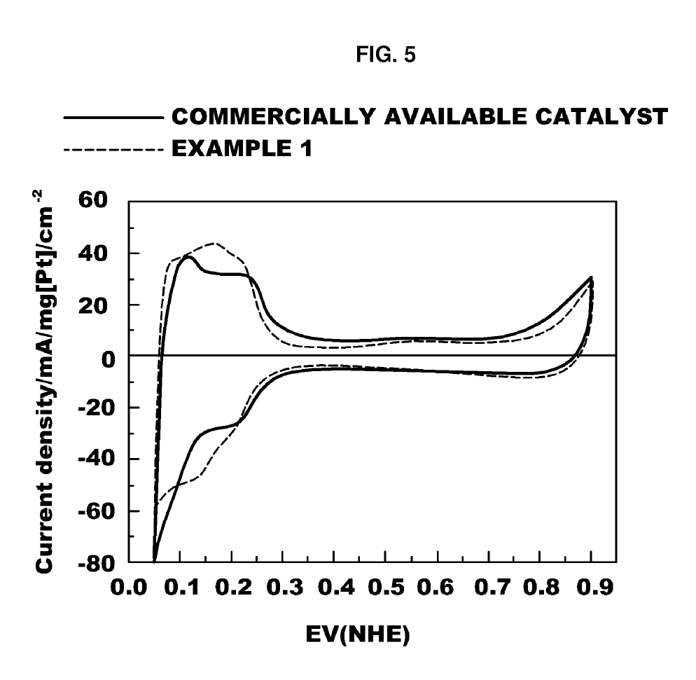

FIG. 5 is a cyclic voltammogram showing the results of cyclic voltammetry measurement of 40 wt % of the PtNi/C alloy catalyst prepared in Example 1 and the commercially available catalyst (40 wt %, Pt/C provided by Johnson & Matthey), measured in a half cell. In FIG. 5, the current density is a value per 1 mg of platinum applied to the electrode per unit electrode area. The area for hydrogen absorption and desorption is similar to or slightly larger than that of Pt/C.

Without intending to limit the theory, there may be some reasons for this are as follows. First, it is because that platinum is present on the surface at a surface concentration higher than the nominal ratio, compared with nickel. Second, since the electrode material measured was not subjected to a heat treatment but only to a drying process at a temperature below 100° C., the platinum-nickel structure might be highly disordered due to alloying with nickel. Accordingly, the d-band center of platinum might be upshifted than that of pure platinum nanoparticles. Lastly, the average diameter of the alloy nanoparticles is slightly smaller than that of the commercially available catalyst (Pt/C provided by Johnson & Matthey), which might increase the surface area in that degree. Such results may be associated with the effects of sodium acetate and ammonia. Accordingly, it can be expected that a significant amount of platinum atoms, which may be an active site of the oxygen reduction reaction, is exposed on the surface, in terms of a large area for hydrogen absorption and desorption and an area for oxidation region similar to pure platinum nanoparticles

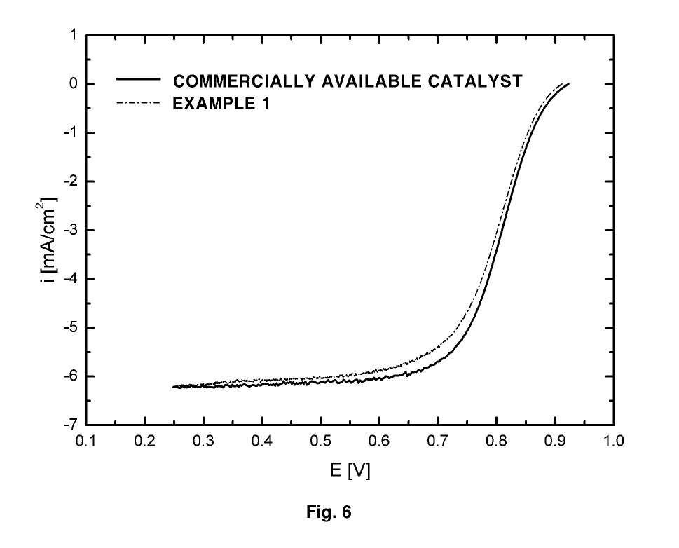

FIG. 6 is a graph showing the results of a rotating disk electrode experiment to measure the activation for oxygen reduction reaction in a half cell of the PtNi/C alloy catalyst prepared in Example 1. 0.5 M of sulfuric acid solution was used as an electrolyte. As shown in FIG. 6, the current density of the PtNi/C alloy catalyst is higher than that of the commercially available catalyst (40 wt %, Pt/C provided by Johnson & Matthey) at the same voltage. When the sulfuric acid solution is used, the absorption of HSO₄⁻ ions becomes the dominant environment, and thus poisoning of OH⁻ ions has little effect. Accordingly, it is determined that the increase in activation of the oxygen reduction reaction is caused by a change in electron structure of the surface platinum, i.e., by a downshift of the d-band center. It is expected that the increase in activation in the half cell may result in improved performance also in the current density measurement in a full cell, and it can be seen from FIG. 6 that the PtNi/C alloy catalyst exhibits performance comparable to or higher than that of the commercially available catalyst.

Meanwhile, it is possible to form a membrane electrode assembly (MEA) for a polymer electrolyte membrane fuel cell using the alloy catalyst of the present invention. In this case, a catalyst layer containing the alloy catalyst and hydrogen ion conductive polymer may be used as either of both an anode and a cathode, and the anode and the cathode are positioned at both ends of the polymer electrolyte membrane. The content of the hydrogen ion conductive polymer may be in the range of 20 to 60 wt % based on the total weight of the alloy catalyst.

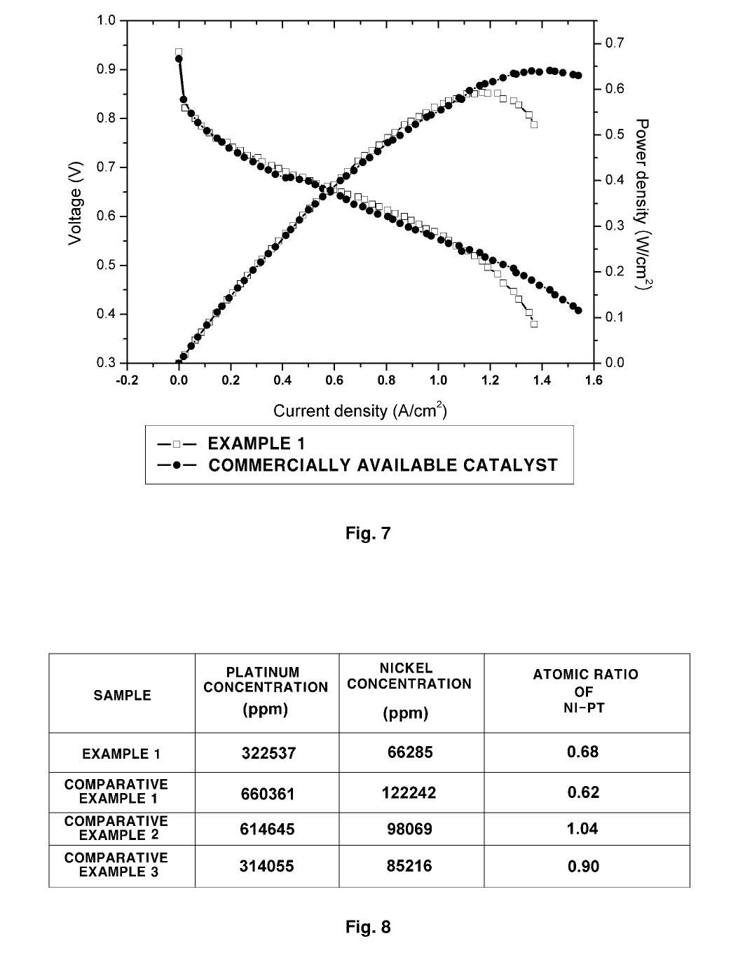

FIG. 7 is a graph showing the results of measurement of current-voltage characteristics of the alloy catalyst prepared in Example 1 using a fuel cell evaluation system. For this purpose, an MEA was formed, a unit cell was connected thereto, and the resulting assembly was applied to the fuel cell evaluation system to perform the evaluation.

First, in order to prepare a catalyst slurry, the alloy catalyst of Example 1 was mixed with a solvent and completely dispersed by performing sonication and stirring. Then, an ionomer (hydrogen ion conductive polymer) was added and completely dispersed by repeatedly performing sonication and stirring. At this time, in order to provide appropriate solid content and viscosity, the solvent was evaporated under reduced pressure. It is preferable that the solid content of the catalyst slurry be in the range of 5 to 30 wt %. The prepared slurry was pulverized using a planetary bead mill to make the particle size smaller and more uniform. Beads having a diameter of 1 to 10 mm were used in an amount of 50 to 500 wt % based on the total weight of the catalyst slurry. It is preferable that the rotational speed be in the range of 20 to 200 rpm and the rotational time in the range of 0.1 to 5 hours. Moreover, it is preferable that the prepared catalyst slurry have a solid content (catalyst and ionomer) in the range of 8 to 30 wt %. The final catalyst slurry was coated on a release paper, dried in the temperature range of 30 to 130° C., and subjected to thermal compression, thus forming an MEA. It is preferable that the temperature of thermal compression be in the range of 100 to 180° C., the time of thermal compression be in the range of 0.5 to 30 minutes, and the pressure of thermal compression be in the range of 50 to 300 kgf. After the thermal compression, the release paper was removed to complete the formation of the MEA. After a gas diffusion layer (GDL) was applied on both ends of the thus formed MEA and a unit cell was connected thereto, the evaluation was performed.

As can be understood from FIG. 7, the unit cell of PtNi/C prepared by the method of the present invention has more excellent performance than that of Pt/C catalyst, a commercially available catalyst. Although the PtNi/C is formed of platinum and nickel in an atomic ratio of 1:1, it exhibits more excellent performance than that of the commercially available pure platinum material, which means that it provides an activation higher than that of the commercially available pure platinum material, although the amount of platinum used is reduced about 23.1% in comparison with the amount of pure platinum.

FIG. 8 is a table showing the results of atomic ratios of platinum and nickel in the alloy catalysts prepared in Example 1 and Comparative Examples 1 to 3, measured using an inductively coupled plasma atomic emission spectrometer, which shows that it is possible to adjust the alloy ratio based on the kind and amount of stabilizer.

Like this, according to the present invention, it is possible to synthesize alloy nanoparticles using an element having a d-band of high electron density, such as platinum, and a transition metal element, and prepare a catalyst in which the alloy particles of platinum and the transition metal element are carried on carbon in a nano-size range.

As described above, according to the method of preparing the platinum alloy catalyst for a fuel cell electrode in accordance with the present invention, it is possible to prepare an alloy catalyst in which nano-sized platinum-transition metal alloy particles are carried on a carbon carrier, and the thus prepared alloy catalyst can be effectively used to form a high-performance catalyst electrode applicable to an anode and a cathode of a fuel cell. Especially, with the use of the alloy catalyst in accordance with the present invention, the amount of platinum used can be reduced, and thus it is possible to reduce the manufacturing cost and manufacture high-performance catalyst electrode and membrane electrode assembly for a fuel cell.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of preparing a platinum alloy catalyst for a fuel cell electrode, the method comprising:
(a) adding a carbon material, a platinum precursor, and a transition metal precursor to ethanol and dispersing the mixture;
(b) adding sodium acetate powder or an ammonia solution containing ethanol as a solvent to the solution obtained in step (a) and stirring the resulting solution;
(c) adding sodium borohydride to the solution obtained in step (b) and reducing the metal ions of the platinum precursor and the transition metal precursor; and
(d) obtaining a platinum alloy catalyst in the form of powder through washing and drying processes.

2. The method of claim 1, wherein, in steps (a) and (b), the ethanol is anhydrous ethanol with a water content of 1% or less.

3. The method of claim 1, wherein, in step (a), the ethanol is used in an amount of 800 to 6400 times the total weight of the metal ions, and in step (b), the sodium acetate powder is used in an amount of 5 to 40 times the total weight of the metal ions, or the ammonia solution containing ammonia is used in an amount of 0.3 to 4 times the total weight of the metal ions.

4. The method of claim 1, wherein the platinum precursor comprises at least one selected from the group consisting of PtCl₄, K₂PtCl₄, H₂PtCl₆.xH₂O, PtCl₂, PtBr₂, and PtO₂.

5. The method of claim 1, wherein the platinum precursor comprises platinum in an amount of 5 to 90 wt % based on the total weight of the carbon material.

6. The method of claim 1, wherein the transition metal precursor is a compound comprising at least one selected from the group consisting of Ni, Co, Fe, Cr, Cu, Ru, Pd, Sn, V, Mo, W, and Ir.

7. The method of claim 6, wherein the transition metal precursor comprises at least one selected from the group consisting of NiCl₂.6H₂O, CoCl₂.6H₂O, NiBr₂, NiCl₂, RuCl₃, CoCl₂, FeCl₂, FeCl₃, FeCl₂.4H₂O, FeCl₃.6H₂O, CrCl₃, CrCl₂, CrCl₃.6H₂O, CuBr₂, CuCl₂, CuCl₂.2H₂O, PdCl₂, PdCl₃, SnCl₂, SnBr₂, SnCl₄, SnCl₂.2H₂O, MoCl₂, MoCl₃, WCl₄, WCl₆, IrCl₃, and IrCl₃.xH₂O.

8. The method of claim 1, wherein the transition metal precursor comprises a transition metal in an amount of 5 to 60 wt % based on the total weight of the platinum.

9. The method of claim 1, wherein the carbon material is one selected from the group consisting of carbon powder, carbon black, acetylene black, ketjen black, active carbon, carbon nanotubes, carbon nanofibers, carbon nanowires, carbon nanohorns, carbon aerogel, carbon xerogel, and carbon nanorings.
